(19) United States
(12) Patent Application Publication
(10) Pub. No.: US 2023/0297177 A1
(43) Pub. Date: Sep. 21, 2023

(54) Touch pad cell phone

(71) Applicant: James V Filomio, JR., Danbury, CT (US)

(72) Inventor: James V Filomio, JR., Danbury, CT (US)

(21) Appl. No.: 17/803,721

(22) Filed: Oct. 31, 2022

Related U.S. Application Data
(63) Continuation-in-part of application No. 17/107,749, filed on Nov. 30, 2020, now abandoned.

(51) Int. Cl. G06F 3/0354; G06F 3/04847

(52) U.S. Cl. CPC G06F 3/03547; G06F 3/04847

(57) ABSTRACT

A smart device that initiate graphical user interfaces(s) of that device, by use of a rear mounted touchpad, an on-screen cursor and clicker buttons. The cursor is moved over the front viewing screen by touchpad input. To initiate an action, the user positions the cursor over a graphical user interface, then pressed one or both clicker buttons. This device is designed to be used one handed.

### BACKGROUND OF INVENTION

The said invention is designed so an electronic hand held ‘smart’ device can be operated one handed. The Touch Sensitive Pad, cursor, taskbar and mounted clicker button(s) initiate devices features of said device one handed. Input (touch) to the Touch Sensitive Pad initiates cursor movement on the front element screen. The Touch pad along with the clicker button(s) navigate the ‘smart’ device and initiate graphical user interface(s). The said invention may display physical buttons that control the (e.g., power) or one embodiment might have an on-screen off button graphical user interface. The said invention incorporates a Traditional style touchpad, a touch sensitive pad that does NOT feature a center-click button on the touchpad itself but relies on separate clicker buttons housed in the devices housing). When the cursor is positioned over a graphical user interface, pressing a clicker button will initiate that application. The housed mounted clicker button(s) maybe also be held down to initiate (e.g. scrolling, highlighting and cut and paste).

The said invention incorporates an on-screen taskbar that allows for ‘swapping’ graphical user interface(s) for quicker use. The taskbar is the location where the on-screen cursor is housed when not in use.

The touchpad is flat and metallic green color, the touch pad is of rectangular shape.

The cursor is metallic green color.

The taskbar can be repositioned on the screen.

The mouse clicker buttons are snap action switch.

The clicker buttons work in sync unless changes made in settings.

Cursor speed on viewing screen can be adjusted in device setting.

### BRIEF SUMMARY OF INVENTION

{0003} The said invention incorporates a Rectangular Touch Sensitive Pad that is metallic green in color, on-screen metallic green cursor on the front element of the hand held device, an on/off switch, either displaying a physical switch or an on-screen graphical user interface in the taskbar, either one or two snap action switches. The input (touch) to the touch sensitive pad initiates movement to the on-screen cursor on the touch screen element, controlling systems and features of the device. When a cursor position is achieved, meaning, positioning the cursor over a graphical user interface, one or both of the mouse clicker buttons are pressed to initiate that application.

When the on-screen cursor is positioned over a graphical user interface, the graphical user interface is highlighted.

The mouse clickers are used to achieve the same outcome. Both clickers are programed to the same measurements and code and pressed together achieve the same command as if one were pressed alone. This makes the device useable in either hand.

Advanced settings of the clicker buttons allows change in actions of the buttons, (e.g. allows one clicker button to only be used for scrolling, answering calls, pressing the ‘GO’ tab to execute a search command.) Factory settings allows clickers to act in the same manner.

The option in the said invention to use a Traditional Touch Sensitive Pad without a center click button, is to avoid unwanted “clicks” when handling or stowing the device.

### BRIEF DESCRIPTION OF SEVERAL VIEWS OF THE DRAWINGS

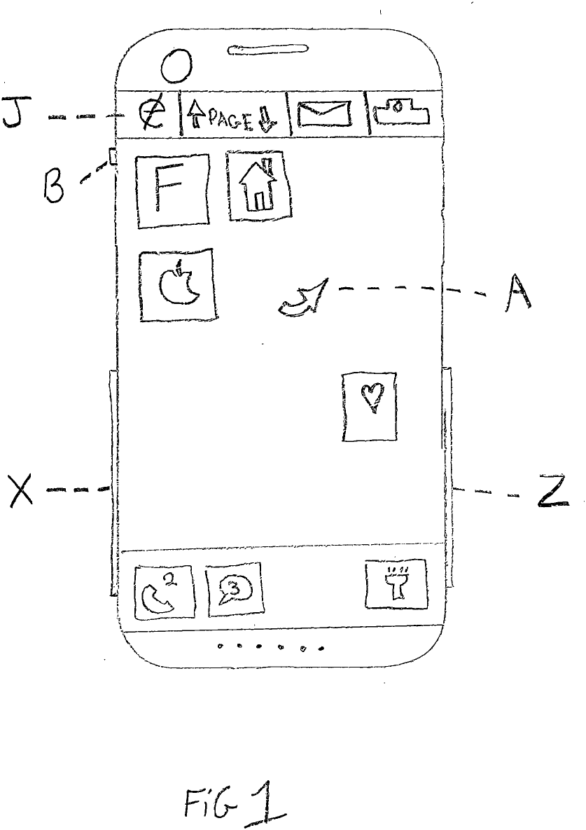

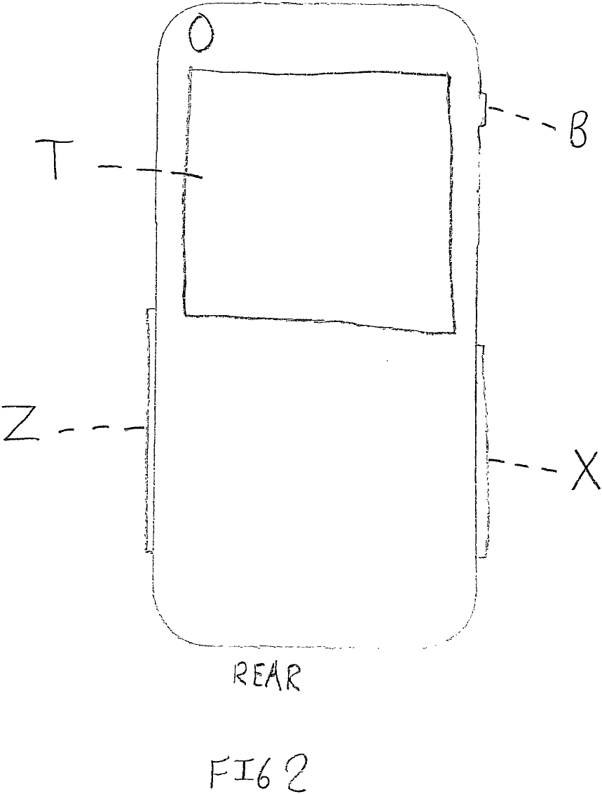

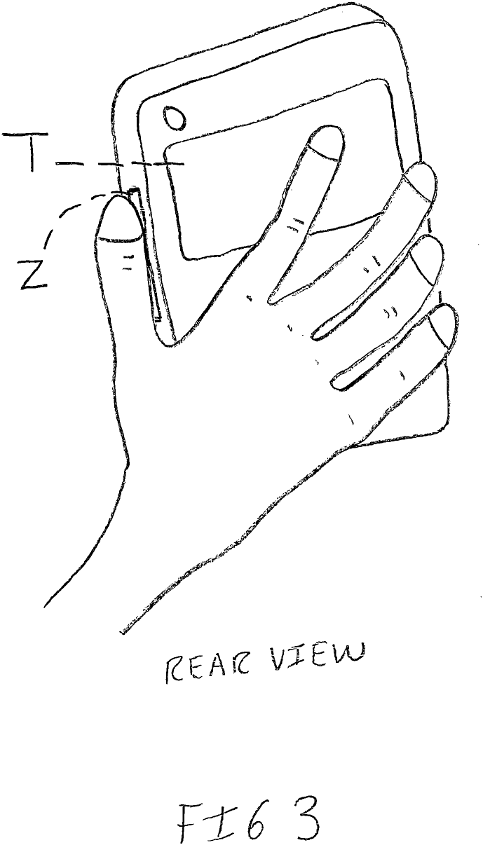

{0004} FIG. 1 of the drawings illustrates an example electronic SMART device (e.g. for this application is a smartphone) touch screen front view of the said invention. The on-screen cursor (A) moves entire surface of front mounted display element. (X), clicker button number 1 and (Z), clicker button number 2, housed opposite each. (J) Illustrates an on-screen Taskbar, where on-screen cursor is located when not in use and also where selected graphical user interface(s) are positioned for easy access. (A) Illustrates metallic green on-screen cursor.

[0005} FIG. 2 and FIG. 3, Illustrates a rear view of an example smart device with an in-housed Touch Sensitive Pad without a center clicker button. (T) Illustrates rear flat green metallic touch surface. (X), (Z) illustrate clicker buttons shown from the rear view. (B) Illustrates Touch Pads on/off switch.

### DETAILED DESCRIPTION OF THE INVENTION

The invention will now be described in detail with reference to a few specific details of the device, systems, patterns, but in no way should be intended to limit the disclosure to the described embodiments.

In electronics the definition of ‘Circuit’ or ‘Circuited’ follows as, ‘A configuration of electrically or electromagnetically connected components of devices’.

The schematic of the components of the invention are circuited to preform further actions below.

FIG. 2, Touch sensitive Pad (T) is located on opposite side of display element on a hand held electronic ‘smart’ device and is operated by input from (e.g. finger(s)) movements as shown in FIG. 3. Touch Sensitive Pad is not limited to size, but is rectangular in shape, flat and of Metallic Green color, Metallic Green color is not limited to brightness or logo.

Touch Sensitive Pad (T) when manipulated by input (touch), will move the cursor (A) FIG. 1, over front display element, and when cursor (A) is positioned over an graphical user interface pressing to one or both ‘click buttons’ (X), (Z), initiating the application.

FIG. 1. (B) Illustrates a power button for only Touch Pad, not the device. Turning button (B) ON, will activate Touch pad (T) and display on-screen cursor, further displaying on-screen task bar.

Cursor (A) is metallic green color and housed in on-screen Taskbar (J) when not in use. Pressing one or both clicker buttons (X), (Z) will drop cursor (A) from taskbar (J).

Cursor (A) can be ‘swiped’ off front screen element by input (touch) over cursor and positioned back to the task bar (J), cursor icon display can be altered in the cursor information setting.

In one embodiment, task bar (J) can be ‘removed’ off display screen by one press of Touch Pad’s ON/OFF button, but is not limited to on-screen cursor (A) still being displayed and used.

Taskbar in one embodiment may be removed from front screen element by a graphical user interface.

If task bar (J) has been removed from display screen, it can be returned back to display element by one press of Touch Pad on/off button.

The design and location of Touch Sensitive Pad (T), allows device to be held and operated in any angle, (vertical or horizontal), so when the device is turned from vertical to horizontal, taskbar (J) and on-screen cursor (A) will adjust with the repositioning to remaining vertical.

Touch Sensitive Pad (T) is a multi-touch surface allowing, (e.g., zooming, realigning the display element, highlighting etc.).

The said invention is not limited to physical buttons or switches.

Input to touch pad (controls cursor movement) cursor (A), by touch movement on Touch Sensitive Pad (T), the movement and location of cursor (A) on front display element is determined by the touch, movement and location on Touch Sensitive Pad (T).

Input to touch pad, (touching, sliding), (e.g. index finger) against Touch Sensitive Pad (T) moves on-screen cursor (A) in accordance to movement against Touch Sensitive Pad.

Example of use, operator slides index finger across the rear touch pad from (bottom to top) positioning front on-screen cursor over graphical user interface (volume tab) in taskbar (J).

Example of use, operator slides index finger across rear touch pad (T) from (bottom to top), positioning front on-screen cursor (A) over graphical user interface (volume UP tab) in task bar (J), pressing clicker button (X) will initiate device’s volume to rise.

Example of use, operator slides index finger across Touch pad (T) from (bottom to top), positioning front on-screen cursor (A) over graphical user interface (volume UP tab) in task bar (J), pressing clicker button (Z) will initiate device’s volume to rise.

Example of use, operator slides index finger across touch pad (T) from (bottom to top), positioning front on-screen cursor (A) over graphical user interface (volume UP tab) in task bar (J), pressing both clicker buttons (X) and (Z) will perform the device’s volume to rise.

Example of use, operator slides index finger across touch pad (T) from (bottom to top), positioning front on-screen cursor (A) to start of word document (job resume) file, pressing and holding down one or both clicker buttons (X), (Z) while sliding (e.g. index finger) down the surface of touch pad (T) will highlight the attended area.

Example of use, the highlighted area (e.g. job resume) can be (copied) by pressing one or both clicker buttons (X),(Z) after operator slides (e.g. index finger) across touch pad (T) to position on-screen cursor over highlighted area, by pressing (e.g. clicker (X) FIG. 1) will display ‘smart’ device’s task bar for (copy, paste, cut), input to touch pad relocates front on- screen cursor over (COPY) tab, pressing (e.g. clicker button (X)) over the selected tab (COPY), the text will be copied.

Example of use, operator slides index finger across touch pad (T) from (left to right), positioning front on-screen cursor (A) over graphical user interface (e.g. ‘PURCHASE’) tab on a ‘online store’, pressing one or both clicker buttons (X), (Z) with initiate the ‘purchase’.

Example of use, operator slides index finger across touch pad (T) from (right to left), positioning front on-screen cursor (A) over graphical user interface (search bar), pressing one or both (Z) (X) clicker buttons will add a ‘text symbol’ (e.g. blinking blue line) to the search bar for starting text or type.

Input to the touch pad and input to the front touch screen can be used simultaneously.

Example of use, operator slides e.g. (index finger) across touch pad from left top, diagonally downward stopping on-screen cursor at graphical user interface icon banking app highlighting the icon, pressing one or both of the (clicker buttons) initiates banking application to active (open).

Example of use, after banking application opens and company’s window (page) comes to view on front screen element, cursor doesn’t leave the screen.

Example of use, ON/OFF button (B), will active touch pad (T), cursor (A) and taskbar (J). Moving (e.g. sliding) power button (B) when the button is ‘ON’ will turn power to touch pad (T) ‘OFF’, removing the cursor (A) and task bar (J) from the front element.

Power button (B) is not limited to design.

Power button (B) is not limited to type of switch, (e.g. press button, switch or soft key).

Power button(s) are not limited to two switches.

Example of use, power on device with power switch or tapping front on-screen element, then active touch pad (T) cursor (A) and taskbar (J) sliding separate power button (B) to on. Pressing one or both clicker buttons (Z), (X) will drop cursor (A) from taskbar (J) onto front screen element.

Example of use, with device main power ‘ON’ touch pad (T) switch may be turned off and device used by the front touch screen element only.

Powering off device main power switch will turn off Touch Pad circuit.

Turning ‘ON’ device main power switch will NOT turn on touch pad (T). Touch Pad (T), cursor (A) and taskbar (J) are circuited with a separate ‘ON’ power switch. Turning ‘OFF’ main power switch WILL turn off touch pad (T), cursor (A) and Taskbar (J). Tapping or input to touchpad will not turn on device.

Example of use, settings adjustment are not limited to, main power switch turning ‘ON’ touch pad.

Task bar (J) can be moved to any location on the front screen element by, positioning the on-screen cursor (A) over the taskbar (J) highlighting area, pressing and holding either or both clicker buttons (X), (Z), input to touch pad will move the taskbar (J) in the direction of input to touch pad. To release the taskbar (J) to a desired position, release the pressed clicker button(s).

Pressing either clicker button (X), (Z) may produce a sound. The sound of the pressing of a clicker button could be controlled in settings.

Clicker button(s) (X), (Z), cursor (A) and touch pad (T) initiate graphical user interface feature of the device that the front touch screen and input (touch) could accomplish.

Touch Sensitive Pad (T) does not have a center click button.

Example of use, holding device in one hand can initiate systems and applications of device. Turn on device. Turn touch pad on with button (B). Pressing (e.g. clicker button (Z)) drops cursor (A) from task bar (J). Input to touch pad (T) moves cursor (A) on front screen element. Input on touch pad (T) to guide front element cursor (A) over (e.g. photos graphical user interface icon). When cursor is positioned over photo icon, it will be highlighted and pressing (e.g. clicker button (Z)) initiating application to view photos. To scroll, pressing and holding down (e.g. clicker button (Z)) while input to touch pad (T) is initiated from top to bottom or bottom to top on touch pad surface.

One embodiment for scrolling page down, positioning cursor (A) over task bar (J) and over symbol for scroll down graphical user interface in taskbar (J). When cursor is positioned over down symbol, the symbol will be highlighted, pressing (e.g. clicker button (Z)) and page will begin to move, to stop page movement release pressed clicker button (Z).

When front element cursor (A) is positioned over a graphical user interface the area will be noted in a highlight to indicate location.

Cursor is metallic green.

Touch pad surface is metallic green.

Touch pad is rectangular in shape.

Clicker button(s) are snap action switches.

Example of use, the speed of the cursor on viewing screen is adjustable to preference. Example of one embodiment, a slow sliding input across touch pad from left to right drags the cursor from left to right on viewing screen at the same pace of input on touch pad.

Example of use, in one embodiment, a slow sliding input a cross touch pad from left to right drags the cursor across viewing screen at a rate of 2X as fast as input a cross touch pad.

Cursor speed preference are adjusted in device settings on a sliding scale.

What is claimed is:

1. A method for operating an electronic smart device one handed, comprising:
Display element;
Display element metallic green cursor;
Rectangular Metallic Green touch sensitive pad opposite element display, WITHOUT touch sensitive center clicker button;
two snap action switches, (clicker buttons);
display element graphical user interface taskbar;
power switches;
The input to touch sensitive pad is touch.
In response to input (touch, e.g. finger(s)) on touch sensitive pad, controlled movement of display element cursor will;
initiate in the same direction as input to touch sensitive pad;
Positioning cursor over a graphical user interface highlights area, pressing one or
both ‘clicker buttons’ initiates highlighted graphical user interface application.
Positioning cursor while holding down one or both clicker buttons initiates one or more device Features (e.g. highlighting).

2. The method of claim 1 wherein actions comprises launching devices systems, applications and future device upgrade and operators applications.

3. The method of claim 1 wherein actions comprising initiating devices Operating system, applications, hardware system and software systems.

4. The method of claim 1 wherein one embodiment said power switch is not limited and may act as a soft key button.

5. The method of claim 1 wherein the act of on-screen taskbar to be repositioned on the front screen element.

6. The method of claim 1 wherein the act of taskbar displaying operator selected graphical user Interface, housing display element cursor when not in use and cursor is controlled time sensitive to return to task bar after set time of inactivity, wherein when cursor is stowed in taskbar, touchpad is disabled.

7. The method of claim 1 wherein the act of removing taskbar from front display element.

8. The method of claim 1 wherein the act of removing cursor from taskbar.

9. The method of claim 1 wherein the act of ‘swiping’ cursor back onto the taskbar from the front touch screen display element.

10. The method of claim 1 wherein the act of rotation of device initiates taskbar and cursor to rotate accordingly.

11. The method of claim 1 wherein the act of rotation of device initiates user input to touch sensitive pad to adjust;
A. Device held vertically, input to touch pad in a ‘north to south’ manner initiates display element cursor to move ‘north to south’.
B. Device held horizontally, input to touch pad in a ‘north to south’ manner initiates display element cursor to move ‘north to south’.

12. An electronic smart device comprising;
A housing;
A cursor on front display element;
A taskbar on front display element;
Two snap action switches (aka, clicker buttons);
A Rectangular Metallic Green touch sensitive pad, without pressure sensitive center clicker button;
A power switch and circuitry for touch pad;
A switch and circuitry to remove/replace taskbar;
A memory;
One or more processors;
Operational settings menu;
.

13. The device of claim 15 wherein front viewing element is touch screen.

14. The device of claim 15 wherein device initiates graphical user interface(s).

15. The device of claim 15 wherein task bars graphical user interface can be selected and unselected.

16. The device of claim 15 wherein the two switches (mouse clickers) are not limited to one.

17. The device of claim 15 wherein two switches, (mouse clickers) may be held down to Initiate graphical user interface compatible actions.

18. The device of claim 15 wherein one embodiment, pressing mouse clickers initiates a sound or vibration.

19. The device of claim 15, wherein speed of on-screen cursor is adjustable against the speed of the input on touch pad.

20. The device of claim 15, wherein the snap action switches are not limited to size, shape or design.
